(19) United States
(12) Patent Application Publication
(10) Pub. No.: US 2026/0160645 A1
(43) Pub. Date: Jun. 11, 2026

(54) ELECTROMAGNETIC WAVE BLOCKING STRUCTURE AND CHASSIS DYNAMOMETER SYSTEM

(71) Applicant: Mitsubishi Electric Corporation, Tokyo (JP)

(72) Inventors: Takeshi UCHIDA, Tokyo (JP); Jun NISHIJIMA, Tokyo (JP); Tetsu OWADA, Tokyo (JP)

(73) Assignee: Mitsubishi Electric Corporation, Tokyo (JP)

(21) Appl. No.: 19/406,428

(22) Filed: Dec. 2, 2025

Related U.S. Application Data
(63) Continuation of application No. PCT/JP2023/022521, filed on Jun. 19, 2023.

(51) Int. Cl. G01M 17/007

(52) U.S. Cl. CPC G01M 17/0074

(57) ABSTRACT

An electromagnetic wave blocking structure includes: an electrically conductive flat belt that is wound around a pair of rollers arranged in parallel below a metal floor, and is exposed through an opening formed in the metal floor in such a manner that a tire of a vehicle are placed thereon; and an electrically conductive electromagnetic wave blocking roller that is disposed between the metal floor and the flat belt at the opening, is conductively connected with the metal floor, and is in contact with the flat belt to rotate along with the movement of the flat belt.

### CROSS REFERENCE TO RELATED APPLICATION

This application is a Continuation of PCT International Application No. PCT/JP 2023/022521, filed on Jun. 19, 2023, which is hereby expressly incorporated by reference into the present application.

### TECHNICAL FIELD

The present disclosure relates to an electromagnetic wave blocking structure and a chassis dynamometer system.

### BACKGROUND ART

Chassis dynamometer systems are systems for conducting tests related to vehicle running, and, for example, measure forces exerted by rotating tires, the peripheral velocity of the tires, and the like.

In a case where vehicles of a vehicle model with a different wheelbase, which is the interval between front wheels and rear wheels, are vehicles under test, conventional chassis dynamometer systems require changing the interval between a front wheel roller and a rear wheel roller to match the wheelbase. In this case, large-scale construction work is required, including excavating the floor, and changing the interval between the front wheel roller and the rear wheel roller to match the wheelbase.

For example, there is a vehicle running test apparatus described in Patent Literature 1 as a conventional technology for solving the problem. This vehicle running test apparatus is a chassis dynamometer system including a pair of rollers arranged in parallel under the floor, and a flat belt wound around the rollers. The differences in the wheelbases of vehicles are absorbed by the longitudinal length of the flat belt. This eliminates the need for construction work to move the rollers to match the wheelbases, and enables tests for various vehicle models.

### CITATION LIST

### Patent Literature

Patent Literature 1: JP-2011-169912-A

### SUMMARY OF INVENTION

### Technical Problem

It is necessary to dispose a chassis dynamometer system in an electromagnetic anechoic chamber in a case where electromagnetic compatibility (hereinbelow, referred to as EMC) tests are conducted by simulating vehicle running. On the other hand, a metal floor is adopted for the floor of the electromagnetic anechoic chamber in order to cut off electromagnetic noise. In a case where a chassis dynamometer system using a flat belt is disposed in such an electromagnetic anechoic chamber, it is necessary to form an opening on a surface of the metal floor, and make the flat belt exposed to the electromagnetic anechoic chamber through the opening. Because of this, there has been a problem with conventional chassis dynamometer systems that there is a possibility that electromagnetic noise emitted from the drive unit of a flat belt, and electromagnetic noise emitted from a device under test in an electromagnetic anechoic chamber are propagated to the inside and outside of the electromagnetic anechoic chamber through the opening.

The present disclosure aims to solve the problem, and an object thereof is to obtain an electromagnetic wave blocking structure that can block electromagnetic waves propagating through an opening formed on a surface of a metal floor in a chamber in which a chassis dynamometer system is disposed.

### Solution to Problem

An electromagnetic wave blocking structure according to the present disclosure is an electromagnetic wave blocking structure included in a chassis dynamometer system capable of executing a simulation of a vehicle above a metal floor, and includes:
an electrically conductive flat belt that is wound around a pair of rollers arranged in parallel below the metal floor, and is exposed through an opening formed on a surface of the metal floor in such a manner that a tire of the vehicle is placed thereon; and an electrically conductive electromagnetic wave blocking roller that is disposed between the metal floor and the flat belt at the opening, is conductively connected with the metal floor, and is in contact with the flat belt to rotate along with movement of the flat belt.

### Advantageous Effects of Invention

According to the present disclosure, an electrically conductive flat belt that is exposed through an opening formed on a surface of a metal floor in such a manner that a tire of a vehicle are placed thereon; and an electrically conductive electromagnetic wave blocking roller that is disposed between the metal floor and the flat belt at the opening, is conductively connected with the metal floor, and is in contact with the flat belt to rotate along with movement of the flat belt are included. Thereby, the flat belt becomes equipotential with the metal floor. Accordingly, the electromagnetic wave blocking structure according to the present disclosure can block electromagnetic waves propagating through the opening formed on the surface of the metal floor in a chamber in which a chassis dynamometer system is disposed.

### BRIEF DESCRIPTION OF DRAWINGS

FIG. 1 is a side view schematically illustrating a chassis dynamometer system according to a first embodiment.

FIGS. 2A and 2B are drawings schematically illustrating an EMC test on a vehicle executed in an electromagnetic anechoic chamber.

FIG. 3 is a side view schematically illustrating an electromagnetic wave blocking structure according to the first embodiment.

FIG. 4 is a top view schematically illustrating the electromagnetic wave blocking structure according to the first embodiment.

FIG. 5 is a top view schematically illustrating a modification example (1) of the electromagnetic wave blocking structure according to the first embodiment.

FIG. 6 is a side view schematically illustrating the modification example (1) of the electromagnetic wave blocking structure according to the first embodiment.

FIG. 7 is a top view schematically illustrating a modification example (2) of the electromagnetic wave blocking structure according to the first embodiment.

FIG. 8 is a top view schematically illustrating a modification example (3) of the electromagnetic wave blocking structure according to the first embodiment.

FIGS. 9A and 9B are side views schematically illustrating a modification example (4) of the electromagnetic wave blocking structure according to the first embodiment.

FIG. 10 is a side view schematically illustrating a chassis dynamometer system according to a second embodiment.

FIG. 11 is a side view schematically illustrating an electromagnetic wave blocking structure according to the second embodiment.

FIG. 12 is a top view schematically illustrating the electromagnetic wave blocking structure according to the second embodiment.

FIGS. 13A and 13B are front views schematically illustrating a roller of the electromagnetic wave blocking structure according to the second embodiment.

FIGS. 14A and 14B are front views schematically illustrating the electromagnetic wave blocking structure according to the second embodiment.

### DESCRIPTION OF EMBODIMENTS

### First Embodiment.

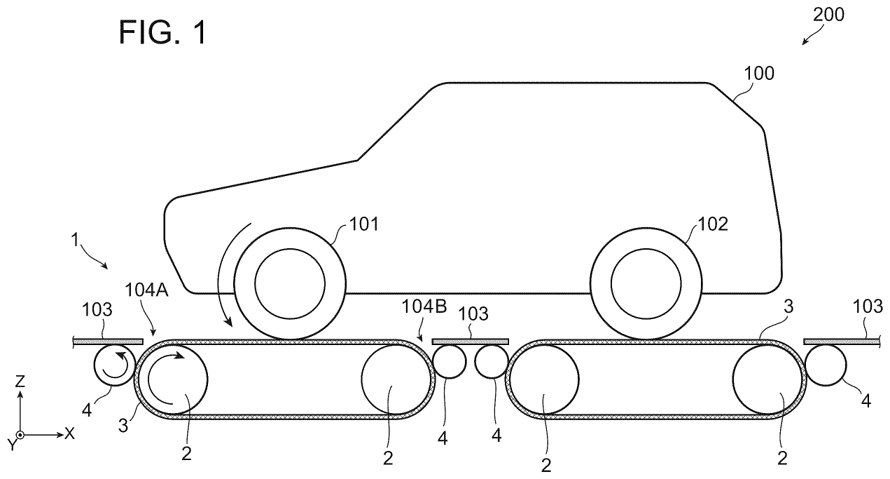

FIG. 1 is a side view schematically illustrating a chassis dynamometer system 200 according to a first embodiment. In FIG. 1, the chassis dynamometer system 200 is a system capable of executing simulations of a vehicle 100 on the surface of a metal floor 103. For example, the chassis dynamometer system 200 is provided in an electromagnetic anechoic chamber having the metal floor 103. As illustrated in FIG. 1, the chassis dynamometer system 200 includes an electromagnetic wave blocking structure 1 disposed under the metal floor 103.

The electromagnetic wave blocking structure 1 includes: a flat belt 3 provided for front tires 101 and rear tires 102 included in the vehicle 100 which is a vehicle under test, and wound around a pair of rollers 2; and an electromagnetic wave blocking roller 4. An opening is formed in the metal floor 103, and the flat belt 3 wound around the rollers 2 is exposed through the opening to the inside of the electromagnetic anechoic chamber.

In addition, as illustrated in FIG. 1, the pair of rollers 2 is arranged in parallel under the metal floor 103. Because of this, the flat portion of the flat belt 3 wound around the rollers 2 becomes almost parallel with the surface of the metal floor 103. The vehicle 100 is disposed in the electromagnetic anechoic chamber in a state where the tires 101 and 102 are placed on the flat portion of the flat belt 3.

For example, by rotating the tires 101 in the direction of an arrow illustrated in FIG. 1, the rollers 2 rotate in the direction opposite to that of the tires 101, and the flat belt 3 wound around the rollers 2 also rotates accordingly. In this manner, the chassis dynamometer system 200 is capable of simulating states close to the actual running of the vehicle 100 in a state where the tires 101 and 102 of the vehicle 100 are placed on the flat belt 3.

Note that, although an illustration is omitted in FIG. 1, there is a drive control apparatus for rotating the flat belt 3, that is, for rotating the rollers 2, under the metal floor 103; in addition, a device under test subject to an EMC test is mounted on the vehicle 100. Electronic circuits are mounted on the drive control apparatus and the device under test, and can be noise sources that generate unnecessary electromagnetic waves.

On the other hand, as mentioned above, the opening for making the flat belt 3 exposed is formed in the metal floor 103 of the electromagnetic anechoic chamber. It is necessary to provide clearances between the flat belt 3 and the opening of the metal floor 103 to prevent the metal floor 103 from obstructing the rotary drive of the flat belt 3. Because of this, there is a possibility that electromagnetic noise generated in the noise sources is propagated to the inside and outside of the electromagnetic anechoic chamber through the clearances.

In order to solve this problem, the electromagnetic wave blocking structure 1 is provided with the electrically conductive electromagnetic wave blocking roller 4 between the metal floor 103 and the electrically conductive flat belt 3 at the opening of the metal floor 103.

For example, as illustrated in FIG. 1, at the opening of the metal floor 103, the electromagnetic wave blocking roller 4 is disposed at either or both of a portion 104A where the flat belt 3 emerges from under the floor and a portion 104B where the flat belt 3 goes under the floor.

The electromagnetic wave blocking roller 4 is conductively connected with the metal floor 103, and is provided in such a manner that the roller circumferential surface thereof is in contact with the flat belt 3. Thereby, the electromagnetic wave blocking roller 4 is configured in such a manner that the electromagnetic wave blocking roller 4 rotates along with the movement of the flat belt 3.

For example, in FIG. 1, due to the clockwise rotation of the rollers 2, the flat belt 3 also rotates clockwise. The electromagnetic wave blocking roller 4 in contact with the flat belt 3 rotates counterclockwise along with the rotation of the flat belt 3.

The flat belt 3 is electrically conductive at least on its surface, and the electromagnetic wave blocking roller 4 is an electrically conductive member conductively connected with the metal floor 103. Because of this, by the electromagnetic wave blocking roller 4 coming into contact with the flat belt 3, the flat belt 3 is electrically connected with the metal floor 103 through the electromagnetic wave blocking roller 4, and becomes equipotential (ground potential) with the metal floor 103.

In this manner, the flat belt 3 functions as a large ground surface disposed at the opening formed in the metal floor 103. Accordingly, it is possible to block electromagnetic waves propagating through the opening.

In addition, the electromagnetic wave blocking roller 4 remains in contact with the flat belt 3 by rotating itself along with the rotation of the flat belt 3 even when the flat belt 3 rotates. Because of this, the electromagnetic wave blocking structure 1 can electrically connect the flat belt 3 to the metal floor 103 independently of the rotation of the flat belt 3. Furthermore, since the electromagnetic wave blocking roller 4 rotates while remaining in contact with the flat belt 3, it is possible to also achieve an advantageous effect of being less prone to degradation such as wear as compared to a structure in which metal pieces are simply caused to contact the rotating flat belt 3.

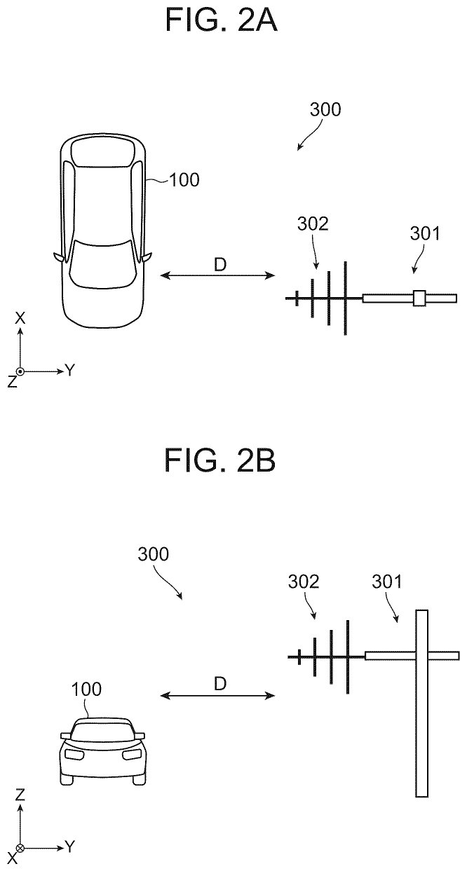

Next, a summary of an EMC test using an electromagnetic anechoic chamber including the chassis dynamometer system 200 is explained. FIG. 2A is a top view schematically illustrating the EMC test on the vehicle 100 executed in an electromagnetic anechoic chamber 300. In addition, FIG. 2B is a front view schematically illustrating the EMC test on the vehicle 100 executed in the electromagnetic anechoic chamber 300. FIGS. 2A and 2B illustrate the electromagnetic anechoic chamber 300 in which the EMC measurement of the vehicle 100 is conducted. Note that, although an illustration is omitted in FIGS. 2A and 2B, it is assumed that the chassis dynamometer system 200 illustrated in FIG. 1 is disposed in the electromagnetic anechoic chamber 300.

In EMC measurement, a reception antenna 302 attached to an antenna mast 301 is used. As illustrated in FIG. 2A, for example, the antenna mast 301 has the reception antenna 302 attached at a position which is at the height of 3 m from the floor. The distance D between the reception antenna 302 and the vehicle 100 is a measurement distance in the EMC measurement, and is set to a distance such as 3 m or 10 m.

In the EMC test, for example, electromagnetic waves emitted from the vehicle 100 are measured using the reception antenna 302 in a situation where a running state of the vehicle 100 is simulated by moving the vehicle 100 with its tires placed on the flat belt 3. At this time, the test may be conducted by changing the measurement distance D. Since the EMC test aims to accurately measure only electromagnetic waves emitted from the vehicle 100, electromagnetic noise from sources other than the vehicle 100 needs to be excluded.

Since the electromagnetic wave blocking structure 1 can cut off electromagnetic noise through the opening formed in the floor of the electromagnetic anechoic chamber 300, it is possible to enhance the precision of the EMC test mentioned above.

Next, the electromagnetic wave blocking structure 1 is explained in detail.

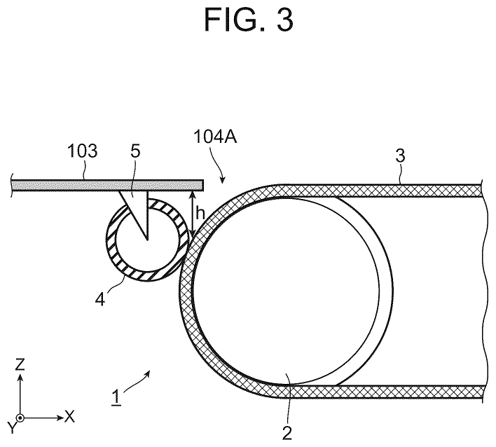

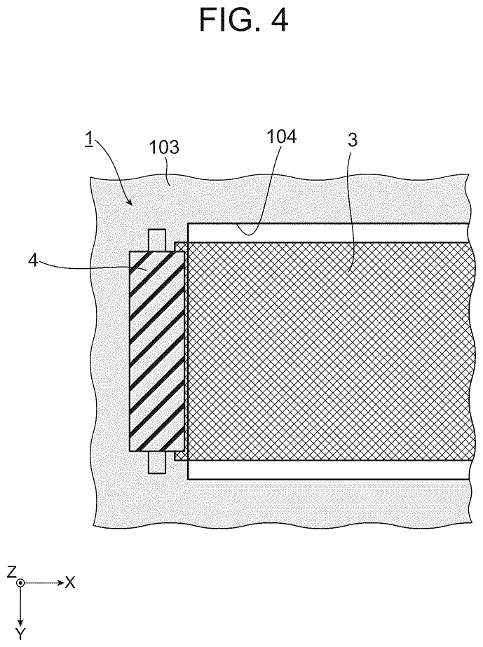

FIG. 3 is a side view schematically illustrating the electromagnetic wave blocking structure 1. In addition, FIG. 4 is a top view schematically illustrating the electromagnetic wave blocking structure 1. In FIG. 4, the metal floor 103 is illustrated as transparent to make the structure under the floor visible. Furthermore, FIGS. 3 and 4 illustrate the electromagnetic wave blocking structure 1 provided at the portion 104A where the flat belt 3 emerges from under the floor at an opening 104 of the metal floor 103. The flat belt 3 is a member including an electrically conductive elastic material. For example, the flat belt 3 may be one formed by incorporating metal powder into an elastic material such as rubber or urethane. In addition, the flat belt 3 may be one formed by coating, with a layer of an electrically conductive material, the surface of a belt formed of an elastic material such as rubber.

The electromagnetic wave blocking roller 4 is an electrically conductive roller that is disposed between the metal floor 103 and the flat belt 3 at the opening 104, is conductively connected with the metal floor 103, and is in contact with the flat belt 3 to rotate along with the movement of the flat belt 3. For example, the electromagnetic wave blocking roller 4 is attached to the back surface of the metal floor 103 by a support member 5. The support member 5 is a metallic member. One end of the support member 5 is attached to the back surface of the metal floor 103, and the other end of the support member 5 is provided with an electrically conductive rotation shaft. The electromagnetic wave blocking roller 4 rotates about the rotation shaft, and is electrically connected with the metal floor 103 through the rotation shaft and the support member 5.

In addition, as illustrated in FIG. 3, the height h of the support member 5 is designed to position a part of the circumferential surface of the electromagnetic wave blocking roller 4 in such a manner that the part contacts the flat belt 3.

Furthermore, as illustrated in FIG. 4, the electromagnetic wave blocking roller 4 may be a single roller extending in the widthwise direction of the flat belt 3. The single electromagnetic wave blocking roller 4 blocks the gap between the flat belt 3 and the metal floor 103 in the widthwise direction of the flat belt 3. Accordingly, it is possible to block unnecessary electromagnetic waves propagating through the gap.

Note that, whereas the electromagnetic wave blocking roller 4 is provided at the portion 104A where the flat belt 3 emerges from under the floor in the case illustrated, the electromagnetic wave blocking roller 4 may be provided at the portion 104B where the flat belt 3 goes under the floor.

By providing the electromagnetic wave blocking structure 1 at those portions, it is possible to reliably block unnecessary electromagnetic waves. In addition, the electromagnetic wave blocking structure 1 may be provided for all the tires of the vehicle 100.

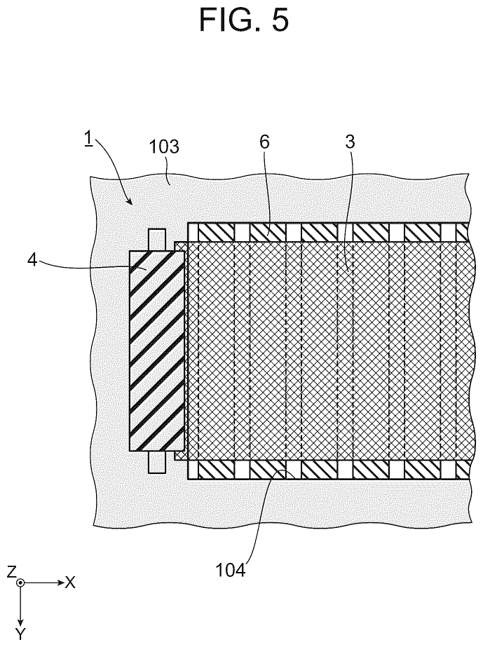

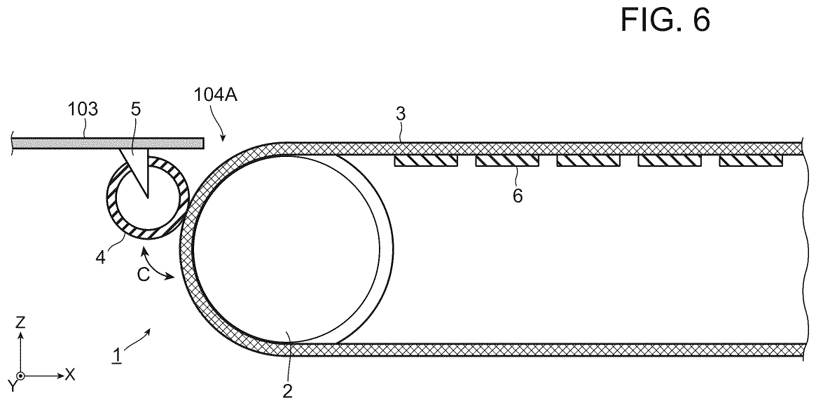

FIG. 5 is a top view schematically illustrating a modification example (1) of the electromagnetic wave blocking structure 1, and illustrates the metal floor 103 as transparent in order to make the structure under the floor visible, for convenience of explanation. In addition, FIG. 6 is a side view schematically illustrating the modification example (1) of the electromagnetic wave blocking structure 1. The modification example (1) of the electromagnetic wave blocking structure 1 illustrated in FIGS. 5 and 6 is provided with one or more metal piece portions 6 that are provided along the longitudinal direction of the flat belt 3, traverse the opening 104 in the widthwise direction of the flat belt 3, and are electrically connected.

Since the metal piece portions 6 are electrically connected to the metal floor 103 at the ground potential, the metal piece portions 6 function as ground surfaces. Whereas it is assumed that the metal piece portions 6 are tabular members as illustrated in FIG. 5, they may be metal rods. By providing the plurality of metal piece portions 6 to the opening 104, it is possible to block the opening 104, and cut off unnecessary electromagnetic waves propagating through the opening 104 independently of the rotation of the flat belt 3.

Note that the flat belt 3 and the electromagnetic wave blocking roller 4 are also electrically connected as represented by an arrow C in the modification example (1) illustrated in FIGS. 5 and 6.

The interval of the plurality of metal piece portions 6 arranged at the opening 104 is determined to prevent the leakage of electromagnetic waves at a predetermined frequency. Electromagnetic waves with frequencies higher than the frequency at which this interval corresponds to half a wavelength are more likely to leak. For example, if the upper limit frequency tolerated in the electromagnetic anechoic chamber 300 is 10 GHz, the half wavelength is 1.5 cm. Accordingly, the interval between the adjacent metal piece portions 6 is made shorter than 1.5 cm. In other words, by making the interval shorter than 1.5 cm, electromagnetic waves with frequencies equal to or lower than 10 GHz are less likely to leak. Note that if the level of electromagnetic noise generated under the floor is low, and is such a level that the leakage of the electromagnetic noise from the interval does not cause a problem, the interval can be made longer.

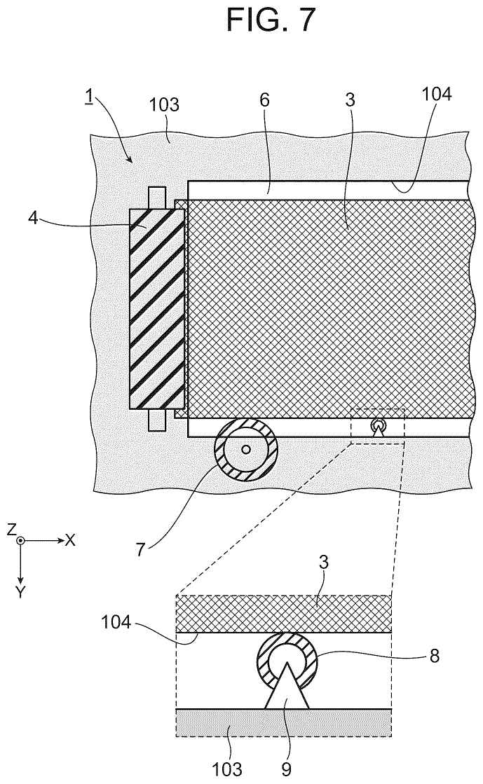

FIG. 7 is a top view schematically illustrating a modification example (2) of the electromagnetic wave blocking structure 1, and illustrates the metal floor 103 as transparent in order to make the structure under the floor visible, for convenience of explanation. The lower drawing in FIG. 7 is an enlarged view of a portion surrounded by a broken line in the upper drawing in FIG. 7. As illustrated in FIG. 7, the electromagnetic wave blocking roller 4 may be one or more side surface rollers 7 or 8 that are provided between the side surfaces of the flat belt 3 and the metal floor 103 at the opening 104.

As illustrated in the upper drawing in FIG. 7, a side surface roller 7 is an electrically conductive roller that rotates about a rotation shaft provided directly to the metal floor 103. The side surface roller 7 electrically connects the flat belt 3 and the metal floor 103 by being in contact with the flat belt 3 at a thickness portion of the flat belt 3.

In addition, as illustrated in the lower drawing in FIG. 7, a side surface roller 8 is an electrically conductive roller that is freely rotatably provided to a support member 9 attached to an end surface of the opening 104. The support member 9 is a metallic member. One end of the support member 9 is attached to the end surface of the opening 104, and the other end of the support member 9 is provided with an electrically conductive rotation shaft. The side surface roller 8 rotates about the rotation shaft, and is electrically connected with the metal floor 103 through the rotation shaft and the support member 9.

Similarly to the side surface roller 7, the side surface roller 8 also electrically connects the flat belt 3 and the metal floor 103 by being in contact with the flat belt 3 at a thickness portion of the flat belt 3.

By providing the side surface rollers 7 or 8, it is possible to cut off unnecessary electromagnetic waves propagating through the gaps between the side surfaces of the flat belt 3 and the metal floor 103.

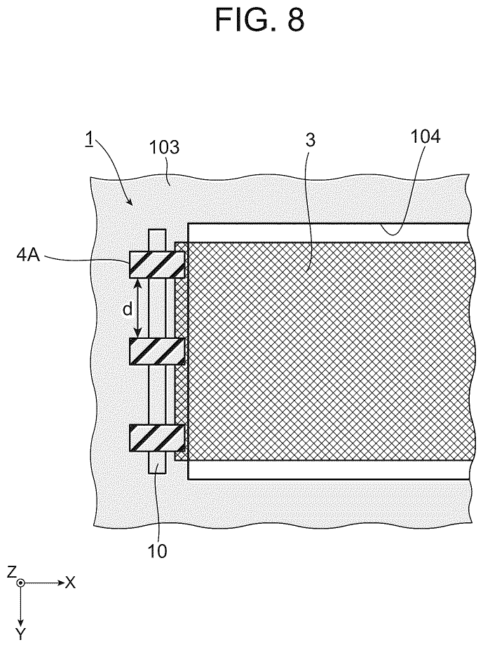

FIG. 8 is a top view schematically illustrating a modification example (3) of the electromagnetic wave blocking structure 1, and illustrates the metal floor 103 as transparent in order to make the structure under the floor visible, for convenience of explanation. As illustrated in FIG. 8, an electromagnetic wave blocking roller 4A is a plurality of partial rollers that are arranged in the widthwise direction of the flat belt 3, and rotate coaxially about a rotation shaft 10. Since the electrically conductive rotation shaft 10 is conductively connected with the metal floor 103, the individual partial rollers function as electrically conductive rollers that are conductively connected with the metal floor 103, and are in contact with the flat belt 3 to rotate along with the movement of the flat belt 3.

The electromagnetic wave blocking roller 4A including the plurality of partial rollers blocks the gap between the flat belt 3 and the metal floor 103 in the widthwise direction of the flat belt 3. Accordingly, it is possible to block unnecessary electromagnetic waves propagating through the gap. Note that the interval d between the adjacent partial rollers in the electromagnetic wave blocking roller 4A is a portion not conductively connected with the metal floor 103. In view of this, the interval d is determined to prevent the leakage of electromagnetic waves at a predetermined frequency. Electromagnetic waves with frequencies higher than the frequency at which the interval d corresponds to half a wavelength are more likely to leak.

For example, if the upper limit frequency tolerated in the electromagnetic anechoic chamber 300 is 10 GHz, the half wavelength is 1.5 cm. Accordingly, the interval d is made shorter than 1.5 cm. In other words, by making the interval d shorter than 1.5 cm, electromagnetic waves with frequencies equal to or lower than 10 GHz are less likely to leak. Note that if the level of electromagnetic noise generated under the floor is low, and is such a level that the leakage of the electromagnetic noise from the interval does not cause a problem, the interval can be made longer.

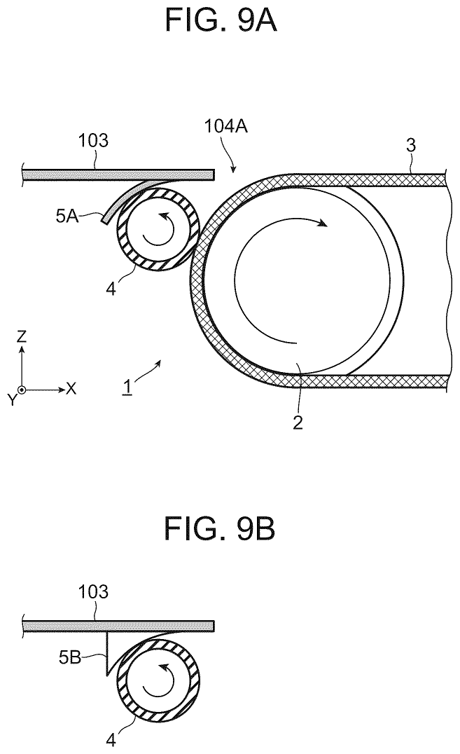

FIG. 9A is a side view schematically illustrating a modification example (4) of the electromagnetic wave blocking structure 1. In addition, FIG. 9B is a partial side view schematically illustrating a modification example of the electromagnetic wave blocking roller 4. In FIGS. 9A and 9B, conductive plates 5A and 5B are conductive portions that are conductively connected with the metal floor 103, and make surface contact with the circumferential surface of the electromagnetic wave blocking roller 4. The electromagnetic wave blocking roller 4 is electrically connected with the metal floor 103 by the conductive plate 5A or 5B.

As illustrated in FIG. 9A, the conductive plate 5A is an electrically conductive tabular member having a curved surface whose one end is attached to the back surface side of the metal floor 103. The curvature of the curved portion of the conductive plate 5A is formed to match the curvature of the electromagnetic wave blocking roller 4, and the conductive plate 5A and the electromagnetic wave blocking roller 4 make surface contact.

In addition, as illustrated in FIG. 9B, the conductive plate 5B is an electrically conductive block-shaped member having a curved surface whose one end is attached to the back surface side of the metal floor 103. Similarly to the conductive plate 5A, the curvature of the curved portion of the conductive plate 5B is also formed to match the curvature of the electromagnetic wave blocking roller 4, and the conductive plate 5B and the electromagnetic wave blocking roller 4 make surface contact.

In this manner, the conductive plates 5A and 5B do not have conductive structures using electrically conductive rotation shafts, but make surface contact with the circumferential surface of the electromagnetic wave blocking roller 4. Thereby, the conductive plates 5A and 5B can lower the impedance between the conductive plates 5A and 5B and the electromagnetic wave blocking roller 4, and more robust grounding is possible. In addition, the conductive plates 5A and 5B can maintain a smooth contact state even when the electromagnetic wave blocking roller 4 rotates.

Note that, whereas the conductive plates 5A and 5B are provided to the electromagnetic wave blocking roller 4 in the cases illustrated, the conductive plate 5A or 5B may be provided to each partial roller of the electromagnetic wave blocking roller 4A mentioned above, or may collectively make surface contact with circumferential portions of the plurality of partial rollers.

As mentioned above, the electromagnetic wave blocking structure 1 according to the first embodiment includes: the electrically conductive flat belt 3 that is wound around the pair of rollers 2 arranged in parallel under the surface of the metal floor 103, and is exposed through the opening 104 formed through the surface of the metal floor 103 in such a manner that the tires 101 and 102 of the vehicle 100 are placed thereon; and the electrically conductive electromagnetic wave blocking roller 4 that is disposed between the metal floor 103 and the flat belt 3 at the opening 104, is conductively connected with the metal floor 103, and is in contact with the flat belt 3 to rotate along with the movement of the flat belt 3. Thereby, the flat belt 3 becomes equipotential with the metal floor 103. Accordingly, the electromagnetic wave blocking structure 1 can block unnecessary electromagnetic waves propagating through the opening 104 formed in the metal floor 103 of the electromagnetic anechoic chamber.

In the electromagnetic wave blocking structure 1 according to the first embodiment, at the opening 104, the electromagnetic wave blocking roller 4 is disposed at either or both of the portion 104A where the flat belt emerges from under the floor and the portion 104B where the flat belt goes under the floor, and is in contact with the flat belt 3 in the widthwise direction of the flat belt 3. Thereby, the electromagnetic wave blocking structure 1 can block electromagnetic waves propagating between the flat belt 3 and the metal floor 103 at the opening 104.

In the electromagnetic wave blocking structure 1 according to the first embodiment, the electromagnetic wave blocking roller 4 is a single roller extending in the widthwise direction of the flat belt 3. Thereby, it is possible to reliably establish a conductive connection between the electromagnetic wave blocking roller 4 conductively connected with the flat belt 3.

In the electromagnetic wave blocking structure 1 according to the first embodiment, the electromagnetic wave blocking roller 4A is a plurality of partial rollers that are arranged in the widthwise direction of the flat belt 3, and rotate coaxially. Thereby, it is possible to reliably establish a conductive connection between the electromagnetic wave blocking roller 4A and the flat belt 3.

The electromagnetic wave blocking structure 1 according to the first embodiment includes the one or more metal piece portions 6 that are provided along the longitudinal direction of the flat belt 3, traverse the opening 104 in the widthwise direction of the flat belt 3, and are electrically connected. By including the plurality of metal piece portions 6, it is possible to block electromagnetic waves propagating between the lateral sides of the flat belt 3 and the metal floor 103.

In the electromagnetic wave blocking structure 1 according to the first embodiment, the electromagnetic wave blocking roller is one or more side surface rollers 7 and 8 provided between the side surfaces of the flat belt 3 and the metal floor 103 at the opening 104. By including the side surface rollers, it is possible to block electromagnetic waves propagating between the lateral sides of the flat belt 3 and the metal floor 103.

The electromagnetic wave blocking structure 1 according to the first embodiment includes the conductive plate 5A or 5B that is conductively connected with the metal floor 103, and makes surface contact with the circumferential surface of the electromagnetic wave blocking roller 4 or 4A. The electromagnetic wave blocking roller 4 or 4A is electrically connected with the metal floor 103 by the conductive plate 5A or 5B.

By including the conductive plate 5A or 5B, it is possible to reliably establish a conductive connection between the electromagnetic wave blocking roller 4 or 4A and the metal floor 103.

Since the chassis dynamometer system 200 according to the first embodiment includes the electromagnetic wave blocking structure 1, it is possible to block unnecessary electromagnetic waves propagating through the opening 104 formed in the metal floor 103 of the electromagnetic anechoic chamber.

### Second Embodiment

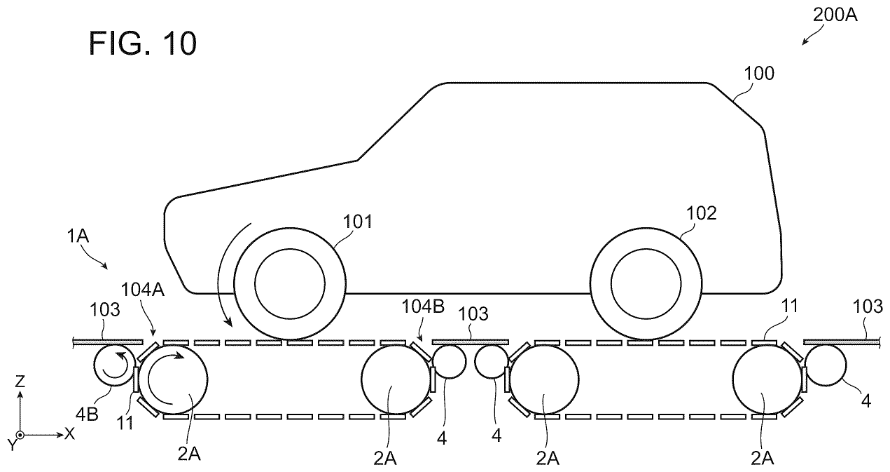

FIG. 10 is a side view schematically illustrating a chassis dynamometer system 200A according to a second embodiment. Whereas respective track shoes included in each track 11 are illustrated separately in FIG. 10, adjacent track shoes are actually connected by pins and bosses. In FIG. 10, the chassis dynamometer system 200A is a system capable of executing simulations of a vehicle 100 on the surface of a metal floor 103. For example, the chassis dynamometer system 200A is provided in an electromagnetic anechoic chamber having the metal floor 103. As illustrated in FIG. 10, the chassis dynamometer system 200A includes an electromagnetic wave blocking structure 1A disposed under the metal floor 103.

The electromagnetic wave blocking structure 1A includes: tracks 11 provided for front tires 101 and rear tires 102 included in the vehicle 100 which is a vehicle under test, and wound around a pair of rollers 2A; and an electromagnetic wave blocking roller 4B. An opening is formed in the metal floor 103, and the tracks 11 wound around the rollers 2A are exposed through the opening to the inside of the electromagnetic anechoic chamber.

Note that the rollers 2A are rollers which are electrically conductive at least on their surfaces.

In addition, as illustrated in FIG. 10, the pair of rollers 2A is arranged in parallel under the metal floor 103. Because of this, the flat portions of the tracks 11 wound around the rollers 2A become almost parallel with the surface of the metal floor 103. The vehicle 100 is disposed in the electromagnetic anechoic chamber in a state where the tires 101 and 102 are placed on the flat portions of the tracks 11.

For example, by rotating the tires 101 in the direction of an arrow illustrated in FIG. 10, the rollers 2A rotate in the direction opposite to that of the tires 101, and the tracks 11 wound around the rollers 2A also rotate accordingly. In this manner, the chassis dynamometer system 200A is capable of simulating states close to the actual running of the vehicle 100 in a state where the tires 101 and 102 of the vehicle 100 are placed on the tracks 11.

Note that, although an illustration is omitted in FIG. 10, there is a drive control apparatus for rotating the tracks 11, that is, for rotating the rollers 2A, under the metal floor 103; in addition, a device under test subject to an EMC test is mounted on the vehicle 100. Electronic circuits are mounted on the drive control apparatus and the device under test, and can be noise sources that generate unnecessary electromagnetic waves.

On the other hand, as mentioned above, the opening for making the tracks 11 exposed is formed in the metal floor 103 of the electromagnetic anechoic chamber. It is necessary to provide clearances between the tracks 11 and the opening of the metal floor 103 to prevent the metal floor 103 from obstructing the rotary drive of the tracks 11. Because of this, there is a possibility that electromagnetic noise generated in the noise sources is propagated to the inside and outside of the electromagnetic anechoic chamber through the clearances.

In order to solve this problem, the electromagnetic wave blocking structure 1A is provided with the electrically conductive electromagnetic wave blocking roller 4B between the metal floor 103 and a circumferential portion of a roller 2A at the opening of the metal floor 103. For example, as illustrated in FIG. 10, at the opening of the metal floor 103, the electromagnetic wave blocking roller 4B is disposed at either or both of a portion 104A where the tracks 11 emerge from under the floor and a portion 104B where the tracks 11 go under the floor.

The electromagnetic wave blocking roller 4B is conductively connected with the metal floor 103, and is provided in such a manner that the roller circumferential surface thereof is in contact with the electrically conductive circumferential portion of the roller 2A. Thereby, the electromagnetic wave blocking roller 4B is configured in such a manner that the electromagnetic wave blocking roller 4B rotates along with the movement of the tracks 11. For example, in FIG. 10, due to the clockwise rotation of the rollers 2B, the tracks 11 also rotate clockwise. The electromagnetic wave blocking roller 4B in contact with the circumferential portion of the roller 2A rotates counterclockwise along with the rotation of the tracks 11.

Each track 11 includes a plurality of track shoes that are connected with each other using pins and bosses, and the individual track shoes are electrically conductive. In addition, as mentioned above, the rollers 2A are electrically conductive rollers, and the electromagnetic wave blocking roller 4B is an electrically conductive member conductively connected with the metal floor 103. Because of this, by the electromagnetic wave blocking roller 4B coming into contact with the circumferential portion of the roller 2A, the tracks 11 are electrically connected with the metal floor 103 through the electromagnetic wave blocking roller 4B, and become equipotential (ground potential) with the metal floor 103. In this manner, the tracks 11 function as large ground surfaces arranged at the opening formed in the metal floor 103. Accordingly, it is possible to block electromagnetic waves propagating through the opening.

In addition, the electromagnetic wave blocking roller 4B remains in contact with the circumferential portion of the roller 2A by rotating itself along with the rotation of the tracks 11 even when the tracks 11 rotate. Because of this, the electromagnetic wave blocking structure 1A can electrically connect the tracks 11 to the metal floor 103 independently of the rotation of the tracks 11.

Furthermore, since the electromagnetic wave blocking roller 4B rotates while remaining in contact with the roller 2A, it is possible to also achieve an advantageous effect of being less prone to degradation such as wear as compared to a structure in which metal pieces are simply caused to contact the rotating roller 2A.

Next, an EMC test using an electromagnetic anechoic chamber including the chassis dynamometer system 200A is explained. The chassis dynamometer system 200A is also capable of performing an EMC test on the vehicle 100 by being provided to the electromagnetic anechoic chamber 300 illustrated in FIGS. 2A and 2B. Since the EMC test aims to accurately measure only electromagnetic waves emitted from the vehicle 100, electromagnetic noise from sources other than the vehicle 100 needs to be excluded.

Since the electromagnetic wave blocking structure 1A can cut off electromagnetic noise through the opening formed in the floor of the electromagnetic anechoic chamber 300, it is possible to enhance the precision of the EMC test mentioned above.

Next, the electromagnetic wave blocking structure 1A is explained in detail.

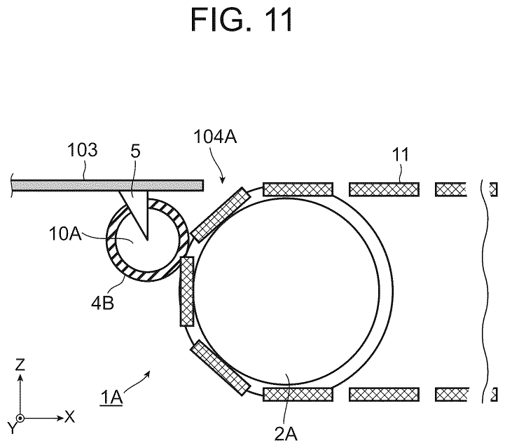

FIG. 11 is a side view schematically illustrating the electromagnetic wave blocking structure 1A. FIG. 11 illustrates the electromagnetic wave blocking structure 1A provided at the portion 104A where the tracks 11 emerge from under the floor at an opening 104 of the metal floor 103. The electromagnetic wave blocking roller 4B is an electrically conductive roller that is disposed between the metal floor 103 and the roller 2A at the opening 104, is conductively connected with the metal floor 103, and is in contact with the roller 2A to rotate along with the movement of the tracks 11.

For example, the electromagnetic wave blocking roller 4B is attached to the back surface of the metal floor 103 by a support member 5. The support member 5 is a metallic member. One end of the support member 5 is attached to the back surface of the metal floor 103, and the other end of the support member 5 is provided with an electrically conductive rotation shaft. The electromagnetic wave blocking roller 4B rotates about the rotation shaft, and is electrically connected with the metal floor 103 through the rotation shaft and the support member 5.

In addition, the height h of the support member 5 is designed to position a part of the circumferential surface of the electromagnetic wave blocking roller 4B in such a manner that the part contacts the circumferential surface of the roller 2A.

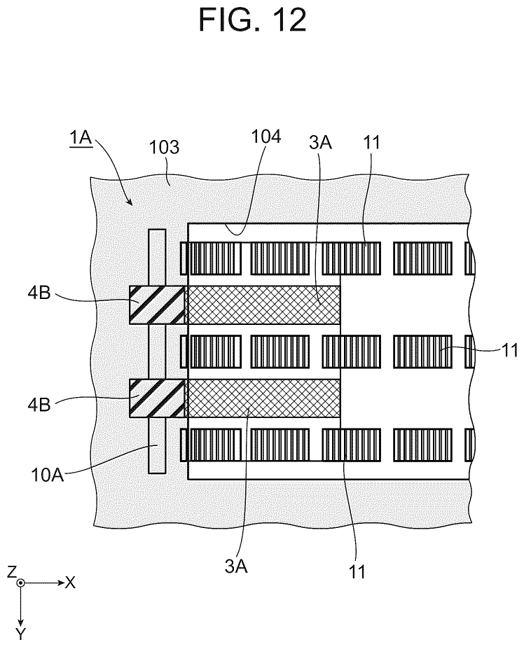

FIG. 12 is a top view schematically illustrating the electromagnetic wave blocking structure 1A, and illustrates the metal floor 103 as transparent in order to make the structure under the floor visible, for convenience of explanation.

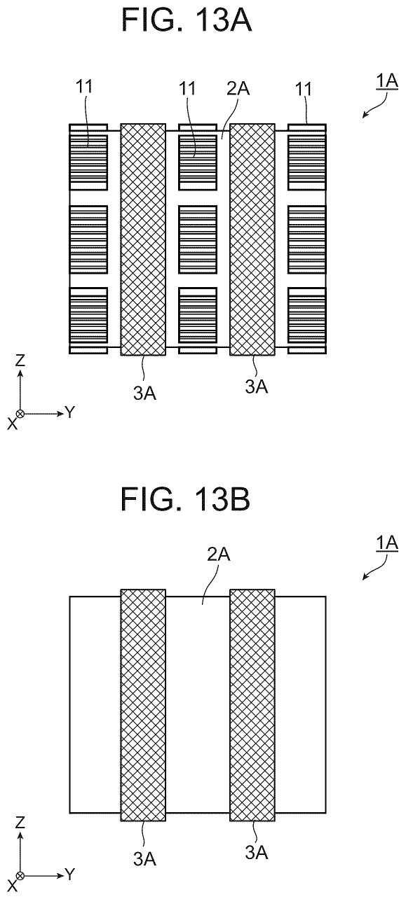

FIG. 13A is a front view schematically illustrating a roller 2A of the electromagnetic wave blocking structure 1A, and illustrates a state where the tracks 11 are wound around the roller 2A. FIG. 13B is a front view schematically illustrating the roller 2A of the electromagnetic wave blocking structure 1A, and illustrates a state where the tracks 11 are removed from the roller 2A.

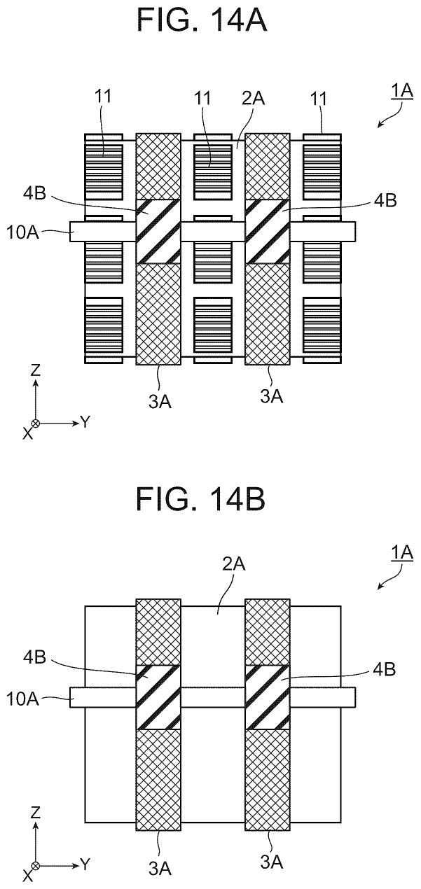

FIG. 14A is a front view schematically illustrating the electromagnetic wave blocking structure 1A, and illustrates a state where the tracks 11 are wound around the roller 2A. FIG. 14B is a front view schematically illustrating the electromagnetic wave blocking structure 1A, and illustrates a state where the tracks 11 are removed from the roller 2A.

Whereas respective track shoes included in each track 11 are illustrated separately in FIGS. 11, 12, 13A, and 14A, adjacent track shoes are actually connected by pins and bosses.

As illustrated in FIGS. 12, 13, and 14, the roller 2A functions as a driving wheel that drives the tracks 11. For example, although an illustration is omitted in FIGS. 13B and 14B, gears for driving the tracks 11 may be formed at portions which are adjacent to circumferential portions 3A of the roller 2A and around which the tracks 11 are wound. Whereas three tracks 11 are wound around a pair of rollers 2A in FIGS. 12, 13, and 14, the number of tracks wounded may be one.

In addition, the electromagnetic wave blocking roller 4B is a plurality of electrically conductive partial rollers that are arranged between the metal floor 103 and the circumferential portions 3A at the opening 104, are conductively connected with the metal floor 103, and are in contact with the circumferential portions 3A of the rollers 2A to rotate along with the movement of the tracks 11.

The electromagnetic wave blocking roller 4B including the plurality of partial rollers blocks the gap between the tracks 11 and the metal floor 103 in the widthwise direction of the tracks 11. Accordingly, it is possible to block unnecessary electromagnetic waves propagating through the gap. Note that the interval between the adjacent partial rollers in the electromagnetic wave blocking roller 4B is a portion not conductively connected with the metal floor 103. In view of this, the interval is determined to prevent the leakage of electromagnetic waves at a predetermined frequency. Electromagnetic waves with frequencies higher than the frequency at which the interval d corresponds to half a wavelength are more likely to leak. For example, if the upper limit frequency tolerated in the electromagnetic anechoic chamber 300 is 10 GHz, the half wavelength is 1.5 cm. Accordingly, the interval between the partial rollers is made shorter than 1.5 cm.

In other words, by making the interval shorter than 1.5 cm, electromagnetic waves with frequencies equal to or lower than 10 GHz are less likely to leak. Note that the level of electromagnetic noise generated under the floor is low, and is such a level that the leakage of the electromagnetic noise from the interval does not cause a problem, the interval can be made longer.

The flat belt 3 illustrated in the first embodiment includes rubber, urethane, or the like. Because of this, extending the flat belt 3 to accommodate the wheelbase of the vehicle 100 makes the flat belt 3 more prone to deflection due to elasticity. In this case, the degree of deflection can be reduced by increasing the width of the flat belt 3; however, this undesirably results in an increased excavation area for disposing the chassis dynamometer system 200 by a corresponding amount.

In contrast, it is possible with the tracks 11 to change the entire lengths of the tracks 11 pitch by pitch, with each pitch corresponding to the length of one track shoe, by adjusting the number of track shoes to be used. Because of this, there is an advantage in that the tracks 11 can be easily configured to have lengths matching the size of the electromagnetic anechoic chamber 300.

Note that, whereas the electromagnetic wave blocking roller 4B is provided at the portion 104A where the tracks 11 emerge from under the floor in the case illustrated, the electromagnetic wave blocking roller 4B may be provided at the portion 104B where the tracks 11 go under the floor.

By providing the electromagnetic wave blocking structure 1A at those portions, it is possible to reliably block unnecessary electromagnetic waves. In addition, the electromagnetic wave blocking structure 1A may be provided for all the tires of the vehicle 100.

In addition, the electromagnetic wave blocking roller 4B may be a single roller extending in the widthwise direction of the flat belt 3. For example, by providing concave portions on the roller circumferential surface to avoid the tracks 11, the electromagnetic wave blocking roller 4B can be configured as a single roller. The single electromagnetic wave blocking roller 4B blocks the gap between the tracks 11 and the metal floor 103 in the widthwise direction of the tracks 11. Accordingly, it is possible to block unnecessary electromagnetic waves propagating through the gap.

In addition, the metal piece portions 6 illustrated in FIGS. 5 and 6 may be provided to the electromagnetic wave blocking structure 1A.

The metal piece portions 6 in the electromagnetic wave blocking structure 1A are one or more metal piece portions that are provided along the longitudinal direction of the tracks 11, traverse the opening 104 in the widthwise direction of the tracks 11, and are electrically connected. Since the metal piece portions 6 are electrically connected to the metal floor 103 at the ground potential, the metal piece portions 6 function as ground surfaces. Whereas it is assumed that the metal piece portions 6 are tabular members, they may be metal rods. By providing the plurality of metal piece portions 6 to the opening 104, it is possible to block the opening 104, and cut off unnecessary electromagnetic waves propagating through the opening 104 independently of the rotation of the tracks 11.

In the electromagnetic wave blocking structure 1A, the interval of the plurality of metal piece portions 6 arranged at the opening 104 is determined to prevent the leakage of electromagnetic waves at a predetermined frequency. Electromagnetic waves with frequencies higher than the frequency at which this interval corresponds to half a wavelength are more likely to leak. For example, if the upper limit frequency tolerated in the electromagnetic anechoic chamber 300 is 10 GHz, the half wavelength is 1.5 cm. Accordingly, the interval between the adjacent metal piece portions 6 is made shorter than 1.5 cm. In other words, by making the interval shorter than 1.5 cm, electromagnetic waves with frequencies equal to or lower than 10 GHz are less likely to leak. Note that if the level of electromagnetic noise generated under the floor is low, and is such a level that the leakage of the electromagnetic noise from the interval does not cause a problem, the interval can be made longer.

In addition, the side surface rollers illustrated in FIG. 7 may be provided to the electromagnetic wave blocking structure 1A.

That is, the electromagnetic wave blocking roller 4B may be the one or more side surface rollers 7 or 8 that are provided between side surfaces of tracks 11 and the metal floor 103 at the opening 104.

As illustrated in the upper drawing in FIG. 7, a side surface roller 7 is an electrically conductive roller that rotates about a rotation shaft provided directly to the metal floor 103. The side surface roller 7 electrically connects a track 11 and the metal floor 103 by being in contact with the track 11 at a thickness portion of the track 11.

In addition, as illustrated in the lower drawing in FIG. 7, a side surface roller 8 is an electrically conductive roller that is freely rotatably provided to a support member 9 attached to an end surface of the opening 104. The support member 9 is a metallic member. One end of the support member 9 is attached to the end surface of the opening 104, and the other end of the support member 9 is provided with an electrically conductive rotation shaft. The side surface roller 8 rotates about the rotation shaft, and is electrically connected with the metal floor 103 through the rotation shaft and the support member 9.

Similarly to the side surface roller 7, the side surface roller 8 also electrically connects a track 11 and the metal floor 103 by being in contact with the track 11 at a thickness portion of the track 11.

By providing the side surface rollers 7 or 8, it is possible to cut off unnecessary electromagnetic waves propagating through the gaps between side surfaces of tracks 11 and the metal floor 103.

In addition, the conductive plates 5A and 5B illustrated in FIGS. 9A and 9B may be provided to the electromagnetic wave blocking structure 1A. The conductive plates 5A and 5B are conductive plates that are conductively connected with the metal floor 103, and make surface contact with the circumferential surface of the electromagnetic wave blocking roller 4B. The electromagnetic wave blocking roller 4B is electrically connected with the metal floor 103 by the conductive plate 5A or 5B.

As illustrated in FIG. 9A, the conductive plate 5A is an electrically conductive tabular member having a curved surface whose one end is attached to the back surface side of the metal floor 103. The curvature of the curved portion of the conductive plate 5A is formed to match the curvature of the electromagnetic wave blocking roller 4B, and the conductive plate 5A and the electromagnetic wave blocking roller 4B make surface contact.

In addition, as illustrated in FIG. 9B, the conductive plate 5B is an electrically conductive block-shaped member having a curved surface whose one end is attached to the back surface side of the metal floor 103. Similarly to the conductive plate 5A, the curvature of the curved portion of the conductive plate 5B is also formed to match the curvature of the electromagnetic wave blocking roller 4B, and the conductive plate 5B and the electromagnetic wave blocking roller 4B make surface contact.

In this manner, the conductive plates 5A and 5B do not have conductive structures using electrically conductive rotation shafts, but make surface contact with the circumferential surface of the electromagnetic wave blocking roller 4B. Thereby, the conductive plates 5A and 5B can lower the impedance between the conductive plates 5A and 5B and the electromagnetic wave blocking roller 4B, and more robust grounding is possible. In addition, the conductive plates 5A and 5B can maintain a smooth contact state even when the electromagnetic wave blocking roller 4B rotates.

As mentioned above, the electromagnetic wave blocking structure 1A according to the second embodiment includes: the tracks 11 that are wound around the pair of rollers 2A arranged in parallel under the surface of the metal floor 103, and are exposed through the opening 104 formed in the metal floor 103 in such a manner that the tires 101 and 102 of the vehicle 100 are placed thereon; the electrically conductive circumferential portions 3A provided on the circumferential surface of one roller of or the circumferential surfaces of both the rollers of the pair of rollers 2A; and the electrically conductive electromagnetic wave blocking roller 4B that is disposed between the metal floor 103 and the circumferential portions 3A at the opening 104, is conductively connected with the metal floor 103, and is in contact with the circumferential portions 3A to rotate along with the movement of the tracks 11. Thereby, the electromagnetic wave blocking structure 1A can block electromagnetic waves propagating between the circumferential portions 3A of the rollers 2A and the metal floor 103 included in the chassis dynamometer system 200 at the opening 104.

In the electromagnetic wave blocking structure 1A according to the second embodiment, at the opening 104, the electromagnetic wave blocking roller 4B is disposed at either or both of the portion 104A where the tracks 11 emerge from under the floor and the portion 104B where the tracks 11 go under the floor. Thereby, the electromagnetic wave blocking structure 1A can block electromagnetic waves propagating between the circumferential portions 3A and the metal floor 103 at the opening 104.

In the electromagnetic wave blocking structure 1A according to the second embodiment, the electromagnetic wave blocking roller 4B is a single roller extending in the widthwise direction of the rollers 2A around which the tracks 11 are wound. Thereby, it is possible to reliably establish a conductive connection between the electromagnetic wave blocking roller 4B and the circumferential portions 3A.

In the electromagnetic wave blocking structure 1A according to the second embodiment, the electromagnetic wave blocking roller 4B is a plurality of partial rollers that are arranged in the widthwise direction of the rollers 2A around which the tracks 11 are wound, and rotate coaxially. Thereby, it is possible to reliably establish a conductive connection between the electromagnetic wave blocking roller 4B and the circumferential portions 3A.

The electromagnetic wave blocking structure 1A according to the second embodiment includes the one or more metal piece portions 6 that are provided along the longitudinal direction of the tracks 11, traverse the opening 104 in the widthwise direction of the tracks 11, and are electrically connected. By including the plurality of metal piece portions 6, it is possible to block electromagnetic waves propagating through the opening 104.

The electromagnetic wave blocking structure 1A according to the second embodiment includes the conductive plate 5A or 5B that is conductively connected with the metal floor 103, and makes surface contact with the circumferential surface of the electromagnetic wave blocking roller 4B. The electromagnetic wave blocking roller 4B is electrically connected with the metal floor 103 by the conductive plate 5A or 5B. By the conductive plate 5A or 5B making surface contact with the circumferential portions 3A of the electromagnetic wave blocking roller 4B, the area of contact therebetween increases. Thereby, the electromagnetic wave blocking structure 1A can reliably establish a conductive connection between the electromagnetic wave blocking roller 4B and the metal floor 103.

In the electromagnetic wave blocking structure 1A according to the second embodiment, the tracks 11 are electrically conductive. By making the electrically conductive tracks 11 conductively connected with the metal floor 103, the floor area including the opening 104 becomes a large ground. Accordingly, it is possible to block unnecessary electromagnetic waves propagating to the inside and outside of the electromagnetic anechoic chamber through the opening 104.

In the electromagnetic wave blocking structure 1A according to the second embodiment, the electromagnetic wave blocking roller 4B is one or more side surface rollers provided between side surfaces of tracks 11 and the metal floor 103 at the opening 104. Thereby, it is possible to reliably establish a conductive connection between the electromagnetic wave blocking roller 4B and the tracks 11.

Since the chassis dynamometer system 200A according to the second embodiment includes the electromagnetic wave blocking structure 1A, it is possible to block unnecessary electromagnetic waves propagating through the opening 104 formed in the metal floor 103 of the electromagnetic anechoic chamber.

Note that combination of respective embodiments, modification of any constituent element in each embodiment, or omission of any constituent element in each embodiment is possible.

### INDUSTRIAL APPLICABILITY

For example, the electromagnetic wave blocking structures according to the present disclosure can be used for a chassis dynamometer system disposed in an electromagnetic anechoic chamber.

### REFERENCE SIGNS LIST

1, 1A: Electromagnetic wave blocking structure; 2, 2A, 2B: Roller; 3: Flat belt; 3A: Circumferential portion; 4, 4A, 4B: Electromagnetic wave blocking roller; 5, 9: Support member; 5A, 5B: Conductive plate; 6: Metal piece portion; 7, 8: Side surface roller; 10: Rotation shaft; 11: Track; 100: Vehicle; 101, 102: Tire; 103: Metal floor; 104: Opening; 104A, 104B: Portion; 200, 200A: Chassis dynamometer system; 300: Electromagnetic anechoic chamber; 301: Antenna mast; 302: Reception antenna

1. An electromagnetic wave blocking structure included in a chassis dynamometer system capable of executing a simulation of a vehicle above a metal floor, the electromagnetic wave blocking structure comprising:
an electrically conductive flat belt that is wound around a pair of rollers arranged in parallel below the metal floor, and is exposed through an opening formed on a surface of the metal floor in such a manner that a tire of the vehicle is placed thereon; and
an electrically conductive electromagnetic wave blocking roller that is disposed between the metal floor and the flat belt at the opening, is conductively connected with the metal floor, and is in contact with the flat belt to rotate along with movement of the flat belt.

2. The electromagnetic wave blocking structure according to claim 1, wherein, at the opening, the electromagnetic wave blocking roller is disposed at either or both a portion where the flat belt emerges from under a floor and a portion where the flat belt goes under the floor, and is in contact with the flat belt in a widthwise direction of the flat belt.

3. The electromagnetic wave blocking structure according to claim 2, wherein the electromagnetic wave blocking roller is a single roller extending in the widthwise direction of the flat belt.

4. The electromagnetic wave blocking structure according to claim 2, wherein the electromagnetic wave blocking roller is a plurality of partial rollers that are arranged in the widthwise direction of the flat belt, and rotate coaxially.

5. The electromagnetic wave blocking structure according to claim 1, comprising one or more metal piece portions that are provided along a longitudinal direction of the flat belt, traverse the opening in a widthwise direction of the flat belt, and are electrically connected.

6. The electromagnetic wave blocking structure according to claim 1, wherein the electromagnetic wave blocking roller is one or more side surface rollers provided between a side surface of the flat belt and the metal floor at the opening.

7. The electromagnetic wave blocking structure according to claim 1, comprising a conductive portion that is conductively connected with the metal floor, and makes surface contact with a circumferential surface of the electromagnetic wave blocking roller, wherein
the electromagnetic wave blocking roller is electrically connected with the metal floor by the conductive portion.

8. An electromagnetic wave blocking structure included in a chassis dynamometer system capable of executing a simulation of a vehicle above a metal floor, the electromagnetic wave blocking structure comprising:
a track that is wound around a pair of rollers arranged in parallel below the metal floor, and is exposed through an opening formed on a surface of the metal floor in such a manner that a tire of the vehicle is placed thereon;
an electrically conductive circumferential portion provided on a circumferential surface of one roller of or circumferential surfaces of both rollers of a pair of the rollers; and
an electrically conductive electromagnetic wave blocking roller that is disposed between the metal floor and the rollers at the opening, is conductively connected with the metal floor, and is in contact with the circumferential portion to rotate along with movement of the track.

9. The electromagnetic wave blocking structure according to claim 8, wherein, at the opening, the electromagnetic wave blocking roller is disposed at either or both of a portion where the track emerges from under a floor and a portion where the track goes under the floor.

10. The electromagnetic wave blocking structure according to claim 9, wherein the electromagnetic wave blocking roller is a single roller extending in a widthwise direction of the rollers around which the track is wound.

11. The electromagnetic wave blocking structure according to claim 9, wherein the electromagnetic wave blocking roller is a plurality of partial rollers that are arranged in a widthwise direction of the rollers around which the track is wound, and rotate coaxially.

12. The electromagnetic wave blocking structure according to claim 8, comprising one or more metal piece portions that are provided along a longitudinal direction of the track, traverse the opening in a widthwise direction of the track, and are electrically connected.

13. The electromagnetic wave blocking structure according to claim 8, comprising a conductive portion that is conductively connected with the surface of the metal floor, and makes surface contact with a circumferential surface of the electromagnetic wave blocking roller, wherein
the electromagnetic wave blocking roller is electrically connected with the metal floor by the conductive portion.

14. The electromagnetic wave blocking structure according to claim 8, wherein the track is electrically conductive.

15. The electromagnetic wave blocking structure according to claim 14, wherein the electromagnetic wave blocking roller is one or more side surface rollers that are provided between a side surface of the track and the metal floor at the opening.

16. A chassis dynamometer system comprising the electromagnetic wave blocking structure according to claim 1.

17. A chassis dynamometer system comprising the electromagnetic wave blocking structure according to claim 8.
